(19) United States
(12) Patent Application Publication
(10) Pub. No.: US 2020/0162653 A1
(43) Pub. Date: May 21, 2020

(54) SIGNAL PROCESSING SYSTEM, SIGNAL PROCESSING DEVICE, AND SIGNAL PROCESSING METHOD

(71) Applicant: SONY CORPORATION, TOKYO (JP)

(72) Inventors: Tetsuro KUWAYAMA, TOKYO (JP); Kenji TANAKA, TOKYO (JP)

(21) Appl. No.: 16/604,638

(22) PCT Filed: Feb. 20, 2018
(86) PCT No.: PCT/JP2018/005942

§ 371 Date: Oct. 11, 2019

(30) Foreign Application Priority Data
Apr. 20, 2017 (JP) 2017-083365

(51) Int. Cl. H04N 5/235; G06K 9/20; G06K 9/00

(52) U.S. Cl. CPC H04N 5/2352; H04N 2005/2255; G06K 9/00134; G06K 9/2027

(57) ABSTRACT

A signal processing system according to an embodiment of the present technology includes: an illumination section; an image capturing section; a parameter control section; and an acquisition section. The illumination section emits laser light to a target. The image capturing section captures an image of the target irradiated with the laser light. The parameter control section changes a parameter related to image capturing of at least one of the illumination section or the image capturing section within exposure time of the image capturing section. The acquisition section acquires movement information related to movement of the target on the basis of an image signal of the target whose image is captured by the image capturing section.

### TECHNICAL FIELD

The present technology relates to a signal processing system, a signal processing device, and a signal processing method that are applicable to detection of a transfer direction and the like of a target.

### BACKGROUND ART

Patent Literature 1 discloses a displacement measurement method using a speckle pattern generated through emission of laser light. According to the displacement measurement method described in Patent Literature 1, an image capturing sensor acquires a speckle pattern of a test target surface at a predetermined frame rate. Next, cross-correlation computation is performed on two speckle patterns acquired at a predetermined time interval. A transfer distance and a transfer speed of the test target surface is measured on the basis of a result of the cross-correlation computation. Note that, a partial region for the measurement is appropriately set with respect to a light reception surface of the image capturing sensor, and computation is performed by using speckle patterns obtained from the partial region. This makes it possible to improve accuracy of the measurement (see paragraphs [0034] to [0088], FIG. 9, FIG. 10, and the like of Patent Literature 1).

### CITATION LIST

### Patent Literature

Patent Literature 1: JP 2015-31623A

### DISCLOSURE OF INVENTION

### Technical Problem

As described above, technologies capable of accurately detecting a displacement of a target have been desired.

In view of the circumstances as described above, a purpose of the present technology is to provide the signal processing system, the signal processing device, and the signal processing method that are capable of accurately detecting a displacement of a target.

### Solution to Problem

In order to achieve the above-mentioned purpose, a signal processing system according to an embodiment of the present technology includes: an illumination section; an image capturing section; a parameter control section; and an acquisition section.

The illumination section emits laser light to a target.

The image capturing section captures an image of the target irradiated with the laser light.

The parameter control section changes a parameter related to image capturing of at least one of the illumination section or the image capturing section within exposure time of the image capturing section.

The acquisition section acquires movement information related to movement of the target on the basis of an image signal of the target whose image is captured by the image capturing section.

In this signal processing system, a parameter related to image capturing of at least one of the illumination section or the image capturing section is changed within the exposure time of the image capturing section. Next, movement information of the target is generated on the basis of the image signal of the target whose image has been captured by the image capturing section. This makes it possible to detect a movement direction and the like of the target on the basis of the image signal obtained through one-time image capturing, for example. As a result, it is possible to accurately detect a displacement of the target.

The acquisition section may acquire the movement information on the basis of information related to a speckle generated through emission of the laser light to the target, the information related to a speckle being included in the image signal.

This makes it possible to accurately detect a displacement of the target.

The image capturing section may include an image sensor that generates the image signal. In this case, the parameter control section may change at least one of intensity of the laser light or gain of the image sensor within the exposure time.

This makes it possible to accurately detect a movement direction and the like of the target on the basis of luminance information or the like included in the image signal.

The parameter control section may change the intensity of the laser light in a manner that change in the intensity of the laser light within the exposure time is asymmetric change based on intermediate time of the exposure time.

This makes it possible to accurately detect a movement direction and the like of the target on the basis of the luminance information or the like included in the image signal.

The parameter control section may change the intensity of the laser light in a manner that intensity of the laser light obtained at an emission start timing of the laser light within the exposure time is different from intensity of the laser light obtained at an emission end timing of the laser light.

This makes it possible to accurately detect an orientation of movement and the like of the target on the basis of the luminance information or the like included in the image signal.

The parameter control section may change the intensity of the laser light in a manner that the intensity of the laser light increases or decreases within the exposure time.

This makes it possible to accurately detect an orientation of movement and the like of the target.

The parameter control section may be capable of controlling emission time from an emission start timing of the laser light to an emission end timing of the laser light within the exposure time.

For example, it is possible to obtain high detection accuracy by controlling emission time in accordance with a movement speed or the like of the target.

The parameter control section may control the emission time in a manner that the emission time is shorter than the exposure time.

This makes it possible to obtain high detection accuracy even in the case where a movement speed of the target is fast.

The acquisition section may acquire the movement information including a relative orientation of movement and a relative movement direction of the target based on an image capturing position of the image capturing section.

The present technology makes it possible to accurately detect a relative orientation of movement and a relative movement direction of the target.

The acquisition section may acquire information including a relative orientation of movement and a relative movement direction of the image capturing section with respect to the target.

The present technology makes it possible to accurately detect a relative orientation of movement and a relative movement direction of the own device including the image capturing section, for example.

The acquisition section may acquire the movement information by comparing a plurality of pixel signals included in the image signal of the target with each other.

For example, it is possible to accurately detect a movement direction and the like of the target on the basis of luminance information included in each pixel signal.

The illumination section may include at least one of a semiconductor laser, a gas laser, a solid-state laser, or a liquid laser.

It is possible to accurately detect a movement direction and the like of the target even in the case of using various kinds of laser light sources.

The image sensor may be a charge coupled device (CCD) sensor or a complementary metal oxide semiconductor (CMOS) sensor.

It is possible to accurately detect a movement direction and the like of the target even in the case of using various kinds of image sensors.

The signal processing system may be configured as an endoscope or a microscope.

It is possible to accurately detect a displacement of a living tissue or the like in a test or the like using an endoscope or a microscope.

The target may be a living tissue.

The present technology makes it possible to accurately detect a blood flow, a transfer of an organ, and the like.

A signal processing device according to an embodiment of the present technology includes: a parameter control section; and an acquisition section.

The parameter control section that changes a parameter related to image capturing of at least one of an illumination section or an image capturing section within exposure time of the image capturing section that captures an image of a target irradiated with laser light emitted from the illumination section.

The acquisition section that acquires movement information related to movement of the target on the basis of an image signal of the target whose image is captured by the image capturing section.

A signal processing method according to an embodiment of the present technology is executed by a computer system and includes changing a parameter related to image capturing of at least one of an illumination section or an image capturing section within exposure time of the image capturing section that captures an image of a target irradiated with laser light emitted from the illumination section.

Movement information related to movement of the target is acquired on the basis of an image signal of the target whose image is captured by the image capturing section.

### Advantageous Effects of Invention

As described above, according to the present technology, it is possible to accurately detect a displacement of a target. Note that, the effects described herein are not necessarily limited and may be any of the effects described in the present disclosure.

### BRIEF DESCRIPTION OF DRAWINGS

FIG. 1 is a diagram schematically illustrating a configuration example of a signal processing system according to an embodiment.

FIG. 2 is a schematic graph illustrating an example of image capturing parameter control exerted by an image capturing control section.

FIG. 3 is a photograph showing an example of a captured image (speckle image) of a subject.

FIG. 4 is a diagram for describing speckle images generated when a subject transfers.

FIG. 5 is a diagram for describing a speckle image obtained when an image capturing parameter is controlled.

FIG. 6 is a diagram for describing speckle image capturing as a comparative example.

FIG. 7 is a flowchart illustrating an example of displacement detection.

FIG. 8 is a diagram for describing displacement detection of each pixel.

FIG. 9 is a flowchart illustrating an example of displacement detection of each pixel.

FIG. 10 is schematic graphs illustrating other examples of parameter control for displacement detection.

FIG. 11 is a schematic diagram for describing other examples of displacement detection of each pixel.

FIG. 12 is a schematic diagram for describing an example of displacement detection of each pixel block.

FIG. 13 is schematic graphs illustrating other examples of parameter control for displacement detection.

FIG. 14 is a diagram schematically illustrating another configuration example of a signal processing system.

### MODE(S) FOR CARRYING OUT THE INVENTION

Hereinafter, embodiments of the present technology will be described with reference to the drawings.

[Configuration of Signal Processing System]

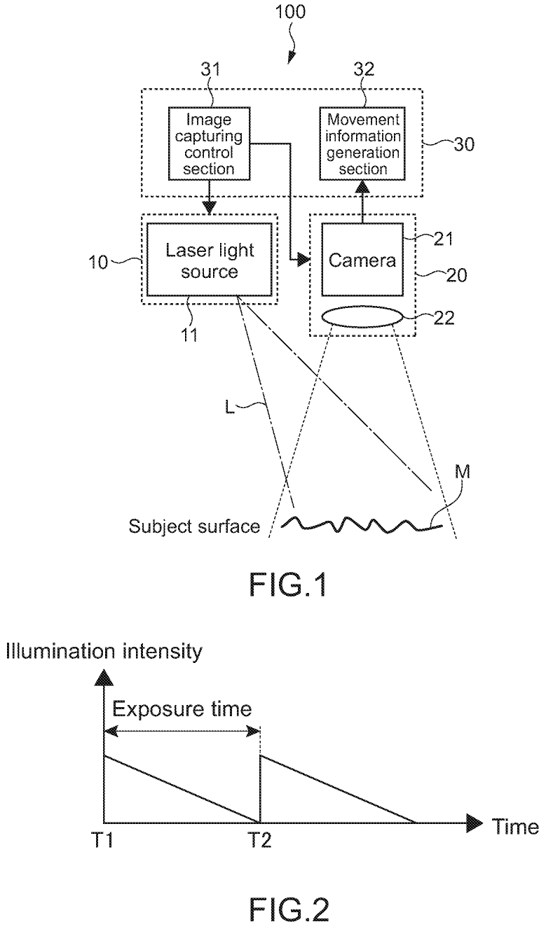

FIG. 1 is a diagram schematically illustrating a configuration example of a signal processing system according to an embodiment of the present technology. A signal processing system 100 includes an illumination unit 10, an image capturing unit 20, and a signal processing device 30. In this embodiment, the illumination unit 10 and the image capturing unit 20 serve as the illumination section and the image capturing section.

The illumination unit 10 emits illumination light to a subject (target) M, which is an image capturing target. As illustrated in FIG. 1, the illumination unit 10 includes a laser light source 11, and emits laser light L to the subject M as the illumination light. The type of the laser light source 11 is not limited. For example, it is possible to use various kinds of laser light sources 11 such as a semiconductor laser, a gas laser, a solid-state laser, and a liquid laser. In addition, the illumination unit 10 may also include a lens system or the like that is capable of adjusting a light flux or the like of the laser light L emitted from the laser light source 11.

The image capturing unit 20 captures an image of the subject M irradiated with the laser light L. As illustrated in FIG. 1, the image capturing unit 20 includes a camera 21 and a lens system 22. The camera 21 includes a two-dimensional image sensor (not illustrated), and generates an image signal of the subject M. The image signal includes pixel signals of respective pixels constituting an image. For example, luminance values (pixel values) of the respective pixels are calculated on the basis of the pixel signals of the respective pixels. It is possible to generate a captured image of the subject M on the basis of the calculated luminance values.

As the image sensor, it is possible to use a charge coupled device (CCD) sensor or a complementary metal oxide semiconductor (CMOS) sensor, for example. Of course, it is possible to use another type of image sensor. The lens system 22 forms an image of the subject M irradiated with the laser light L, on the image sensor of the camera 21. A specific configuration of the lens system 22 is not limited. Note that, FIG. 1 schematically illustrates an image capturing range of the image capturing unit 20.

For example, the signal processing device 30 includes hardware that is necessary for configuring a computer such as a GPUCPU, ROM, RAM, and an HDD. The signal processing method according to the present technology is executed when the CPU loads a program into the RAM and executes the program. The program relates to the present technology and is recorded in the ROM or the like in advance. For example, the signal processing device 30 can be implemented by any computer such as a personal computer (PC). Of course, it is also possible to use hardware such as a GPU, an FPGA, or an ASIC.

As illustrated in FIG. 1, in this embodiment, an image capturing control section 31 and a movement information generation section 32 are configured as functional blocks when the CPU executes a predetermined program. Of course, it is also possible to use dedicated hardware such as an integrated circuit (IC) to implement the respective blocks. The program is installed in the signal processing device 30 via various kinds of recording media, for example. Alternatively, it is also possible to install the program via the Internet.

The image capturing control section 31 is capable of controlling respective operations related to image capturing of the laser light source 11 and the camera 21. For example, the image capturing control section 31 generates a synchronization signal such as a clock signal, synchronizes the laser light source 11 and the camera 21 on the basis of the synchronization signal, and exerts control. It is also possible to exert synchronization control of the laser light source 11 and the camera 21 by using the clock signal or the like generated in the illumination unit 10 or the image capturing unit 20 as the synchronization signal.

In addition, the image capturing control section 31 is capable of controlling respective image capturing parameters related to image capturing of the illumination unit 10 and the image capturing unit 20. The image capturing parameters related to the image capturing include any parameter related to image capturing of the subject M. For example, the image capturing parameter of the illumination unit 10 includes any parameters such as intensity, color, emission time, and the like of the laser light L. The image capturing parameter of the image capturing unit 20 includes any parameters such as exposure time, gain of the image sensor, a focal length, a focus position, an angle of view, and an f-number. In this embodiment, the image capturing control section 31 functions as the parameter control section.

FIG. 2 is a schematic graph illustrating an example of image capturing parameter control exerted by the image capturing control section 31. The image capturing control section 31 is capable of changing respective image capturing parameters of the illumination unit 10 and the image capturing unit 20 within exposure time of the camera 21 of the image capturing unit 20. In this embodiment, as illustrated in FIG. 2, the image capturing control section 31 changes illumination intensity (intensity of the laser light L) within the exposure time.

As illustrated in FIG. 2, T1 represents exposure start time of one-time exposure time, and T2 represents exposure end time. Time from T1 to T2 is the exposure time. In this embodiment, the image capturing control section 31 reduces the illumination intensity from the exposure start time T1 to the exposure end time T2.

At the exposure end time T2, amount of the laser light L is approximately zero, but the amount of the laser light L is instantaneously increased before a next exposure start time T1. Therefore, as illustrated in FIG. 2, the graph showing the change in the illumination intensity has a sawtooth-like line. Accordingly, in this embodiment, the illumination intensity temporally changes in one frame of the image sensor.

For example, amount of current to be applied to the laser light source 11 may be controlled as control of the illumination intensity. For example, by reducing the amount of current to be applied to the laser light source 11 from the exposure start time T1 to the exposure end time T2, it is possible to control illumination intensity as illustrated in FIG. 2.

In addition, it is possible to use an optical element such as an optical filter as an element of the image capturing control section 31, and control the illumination intensity. For example, an ND filer or the like is disposed in an optical path of the laser light L emitted from the laser light source 11. By appropriately rotating the ND filer or the like while maintaining constant intensity of the laser light L, it is possible to control the intensity of the laser light L. As described above, by appropriately synchronizing and controlling the laser light source 11 and the optical element, it is possible to control the illumination intensity as illustrated in FIG. 2. In addition, it is possible to use any control method.

The movement information generation section 32 generates movement information related to movement of the subject M on the basis of the image signal of the subject M whose image is captured by the image capturing unit 20. In this embodiment, the movement information including an orientation of the movement and a movement direction of the subject M is generated. The orientation of movement and the movement direction of the subject M typically correspond to an orientation of transfer and a transfer direction of the subject M.

Next, the description will be given while using an example in which the subject M transfers in a predetermined direction. Therefore, sometimes the movement direction, the orientation of movement, and the movement information are referred to as a transfer direction, an orientation of transfer, and transfer information.

Note that, even in the case where a portion of the subject M moves, it is possible to detect a movement direction and the like of the portion by using the present technology. In other words, the movement of the subject M is not limited to transfer of the subject M. The movement of the subject M includes any movement such as the movement of the portion of the subject M and the like. In this embodiment, the movement information generation section 32 functions as the acquisition section.

[Generation of Movement Information]

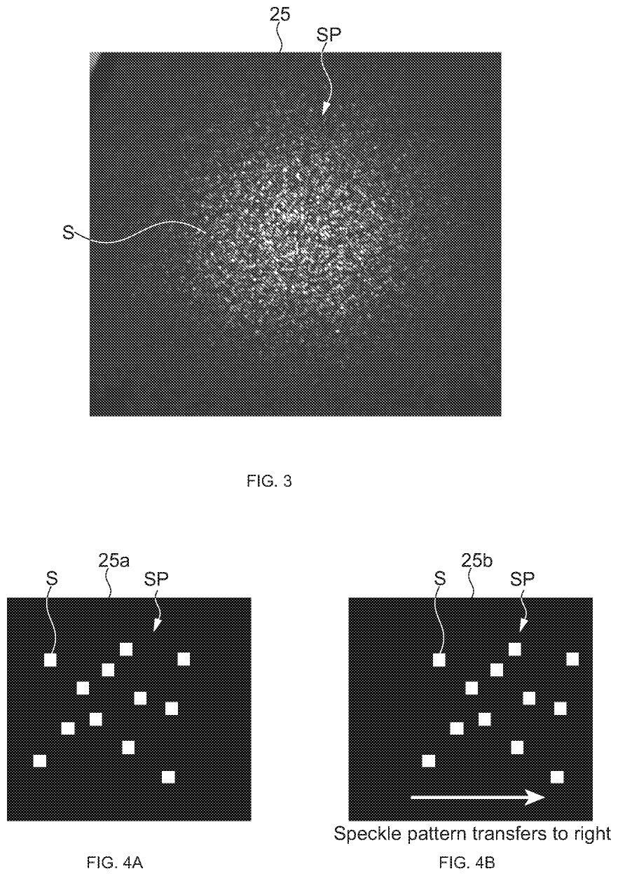

FIG. 3 is a photograph showing an example of a captured image of the subject M. When coherent light such as the laser light L is emitted as illumination light, the laser light L is diffused by fine asperities of a surface of the subject M. As illustrated in FIG. 3, a speckle pattern SP is generated by interference of the diffused laser light L. The speckle pattern SP includes a plurality of speckles (spots) S, and is a pattern corresponding to a surface shape of the subject M and an illumination condition such as an angle of the illumination light.

A speckle image 25 illustrated in FIG. 3 is generated by generating an image on the basis of the image signal generated by the image capturing unit 20. Therefore, the image signal generated by the image capturing unit 20 is a signal including information related to the speckles S. In this embodiment, an orientation of movement and a movement direction of the subject M are estimated on the basis of the information related to the speckles S generated through emission of the laser light L to the subject M, the information related to the speckles S being included in the image signal of the subject M. Subsequently, movement information is generated.

FIG. 4 is a schematic diagram for describing the speckle image generated when the subject M transfers. FIG. 4A is a schematic diagram of a speckle image of the subject M before the transfer. FIG. 4B is a schematic diagram of a speckle image of the subject M after the transfer. Here, it is assumed that the whole subject M transfers to the right along a left-right direction in FIG. 4.

In the case where the subject M transfers, the speckle pattern SP transfers while the pattern is substantially maintained as illustrated in FIG. 4A and FIG. 4B. In other words, the speckle pattern SP before the transfer and the speckle pattern SP after the transfer are substantially the same. Therefore, it is possible to detect a displacement of the speckle pattern SP as a displacement of the subject M by computing correlation between the speckle pattern SP before the transfer and the speckle pattern SP after the transfer. The use of the speckle patterns SP makes it possible to detect transfer amount even in the case where the target M is an object with no pattern or structure (such as a piece of white paper).

However, the above-described method includes the following problems. Although the speckle pattern SP is maintained in the case of a certain transfer amount, the speckle pattern SP often changes in the case of a large transfer amount. In addition, even in the case of a slight transfer, sometimes the speckle pattern SP may change into a speckle pattern SP with a small correlation, depending on an image capturing condition or an illumination condition such as image capturing with high magnification or image capturing with a short image capturing distance. This makes it difficult to detect a displacement of the subject M even when calculating the correlation between the speckle pattern SP before the transfer and the speckle pattern SP after the transfer.

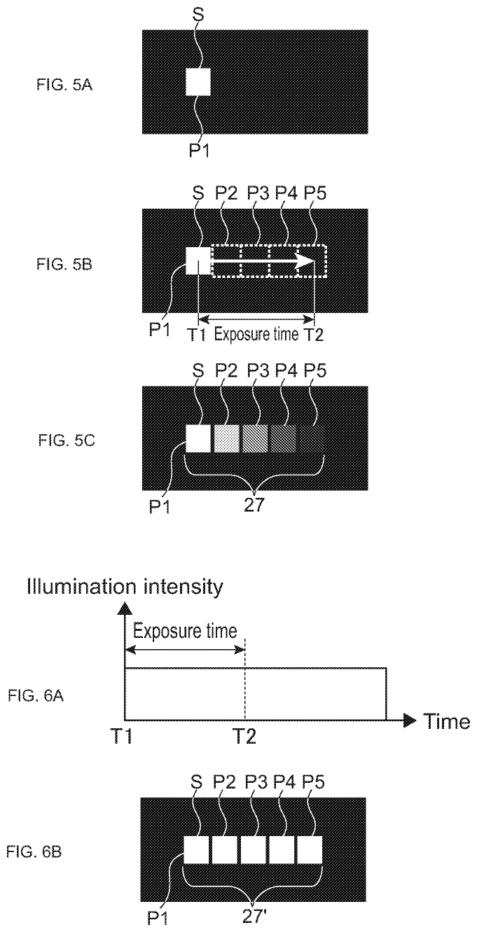

FIG. 5 is a schematic diagram for describing a speckle image obtained in the case where the image capturing control section 31 controls image capturing parameters. FIG. 6 is a schematic diagram for describing speckle image capturing as a comparative example.

FIG. 5A is a schematic diagram illustrating a speckle image displaying a speckle S. To simplify the explanation, it is assumed that the speckle S is displayed by one pixel P1 of the image sensor. In other words, it is assumed that the pixel P1 receives light constituting the speckle S.

As illustrated in FIG. 5B, it is assumed that the subject M transfers to the right by a distance corresponding to four pixels of the image sensor within a certain exposure time (from T1 to t2). In other words, it is assumed that the speckle S transfers to the right by four pixels within the certain exposure time.

When the speckle S transfers, light from the speckle S is incident on pixels P2 to P5 arrayed along the transfer direction. Therefore, the five pixels P1 to P5 respectively generates pixel signals corresponding to light reception amounts of the incident light.

As illustrated in FIG. 2, in this embodiment, the illumination intensity is reduced from the exposure start time T1 to the exposure end time T2. Therefore, within the exposure time, the speckle S gets darker as time elapses, that is, as the speckle S transfers to the right. Accordingly, the light reception amounts of the pixels P1 to P5 are reduced as time elapses. Especially, among the pixels P1 to P5, pixels closer to a front side of an orientation of transfer (the right side) have smaller integral values of the light reception amounts. As a result, the pixel signals generated by the respective pixels P1 to P5 are different from each other, and the pixels closer to the right side generates pixel signals having smaller luminance values (typically, pixel signals having smaller signal intensities).

FIG. 5C is a schematic diagram of a speckle image generated on the basis of the pixel signals generated by the pixels P1 to P5. As illustrated in FIG. 5C, a single speckle image that shows the transferring speckle S is generated in a manner that the luminance values (pixel values) decrease as the speckle S transfers toward the orientation of transfer (to the right). In other words, color gradation appears in the image toward the orientation of transfer.

The speckle S transfers within the exposure time. Therefore, a bar-like image is partially displayed in a manner that a bright point trails along the transfer direction. In the bar-like image, color gradation appears along the orientation of the transfer. The bar-like image representing the transfer of the speckle S is treated as a transfer image 27 of the speckle S. In such a way, the gradational transfer image 27 is generated in this embodiment.

As illustrated in FIG. 6A, it is assumed that the illumination intensity is controlled in a manner that constant illumination intensity is obtained from the exposure start time T1 to the exposure end time T2. This makes it possible to obtain substantially constant light that is incident from the speckle S onto the respective pixels P1 to P5. In other words, unlike the above description, light reception amounts of the respective pixels do not change as the speckle S transfers. Therefore, for example, as illustrated in FIG. 6B, the pixels generate respective pixel signals that are substantially equal to each other. As a result, the speckle image shows a transfer image 27′ of the speckles S with substantially same luminance values.

As described above, in this embodiment, the intensity of the laser light L is changed as an image capturing parameter of the illumination unit 10 in a manner that pixel signals output from respective pixels are changed as the speckle S transfers when the image signal of the speckle image 25 of one frame is generated. This makes it possible to accurately detect a displacement of the subject M on the basis of the luminance information or the like included in the image signal, for example.

Here, a process of changing respective image capturing parameters within the exposure time in a manner that pixel signals output from respective pixels are changed as the speckle S transfers when the image signal of the speckle image 25 of one frame is generated is parameter control for displacement detection. The image capturing control section 31 is also referred to as a block that exerts the parameter control for the displacement detection.

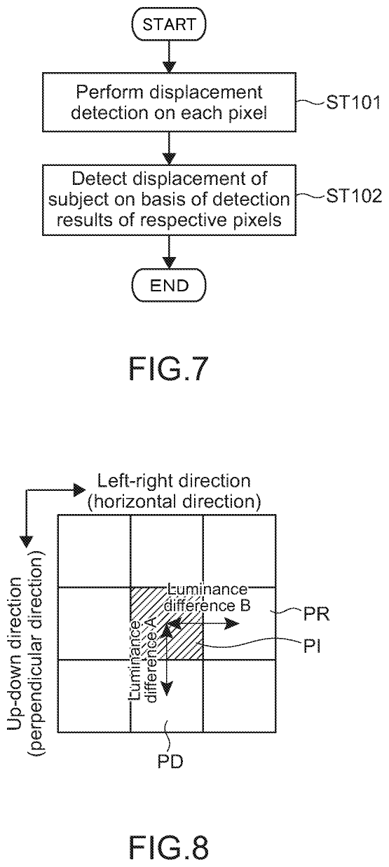

Displacement detection performed in the case where parameter control for displacement detection illustrated in FIG. 2 is exerted will be described. FIG. 7 is a flowchart illustrating an example of the displacement detection. In the example illustrated in FIG. 7, the displacement detection is performed on each pixel on the basis of the plurality of pixel signals included in the image signal (Step 101). Next, a displacement of the subject M is detected on the basis of detection results of the respective pixels (Step 102).

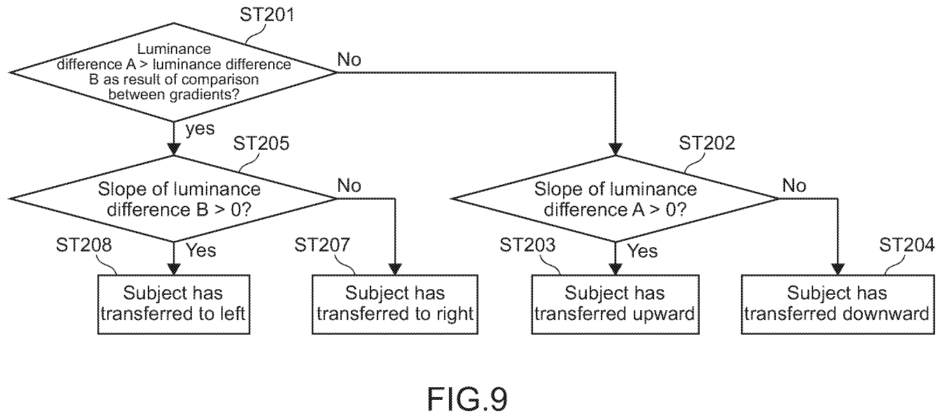

FIG. 8 is a diagram for describing displacement detection of each pixel performed in Step 101. FIG. 9 is a flowchart illustrating an example of the displacement detection of each pixel.

As illustrated in FIG. 8, the description will be given on the assumption that a horizontal direction of a speckle image of the subject M is referred to as a left-right direction, and a perpendicular direction of the speckle image of the subject M is referred to as an up-down direction. In addition, a luminance difference A represents a difference between a luminance value of a target pixel PI serving as a detection target and a luminance value of a pixel PD disposed immediately below the target pixel PI. A luminance difference B represents a difference between the luminance value of the target pixel PI and a luminance value of a pixel PR disposed immediately to the right of the target pixel PI. From the luminance difference A and the luminance difference B, it is possible to calculate pixel information of each of the target pixel PI, the pixel PD disposed immediately below the target pixel PI, and the pixel PR disposed immediately to the right of the target pixel PI.

As illustrated in FIG. 9, first, gradient of the luminance values in the left-right direction is compared with gradient of the luminance value in the up-down direction. Specifically, a magnitude (absolute value) of the luminance difference A is compared with a magnitude (absolute value) of the luminance difference B (Step 201).

As illustrated in FIG. 3 and the like, the speckle image 25 is an image in which the speckles S are randomly disposed. Basically, differences between luminance values of adjacent pixels are relatively large. On the other hand, as illustrated in FIG. 5C, differences of luminance values of adjacent pixels in the transfer direction are small with regard to a portion including the gradational transfer image 27. Therefore, by comparing the gradients in Step 201, it is possible to detect a direction with small luminance differences as an extension direction of the transfer image 27, that is, the transfer direction of the subject M.

In the case where the luminance difference A is smaller (No in Step 201), it is determined that the subject M transfers in the up-down direction, and it is determined whether slope of the luminance difference A is positive or negative (Step 202). The slope of the luminance difference A is slope of luminance values based on the luminance value of the target pixel PI. The slope of the luminance difference A is positive in the case where the luminance value of the pixel PD disposed immediately below the target pixel PI is larger than the luminance value of the target pixel PI. The slope of the luminance difference A is negative in the case where the luminance value of the pixel PD disposed immediately below the target pixel PI is smaller than the luminance value of the target pixel PI.

In this embodiment, the illumination intensity decreases as the subject transfers. Therefore, pixels closer to the front side of the orientation of transfer the transfer have smaller luminance values. In the case where the slope of the luminance difference A is positive (Yes in Step 202), it is determined that the subject has transferred upward (Step 203). In the case where the slope of the luminance difference A is negative (No in Step 202), it is determined that the subject has transferred downward (Step 204).

In the case where the luminance difference B is smaller (Yes in Step 201), it is determined that the subject M has transferred in the left-right direction, and it is determined whether slope of the luminance difference B is positive or negative (Step 205). In the case where the slope of the luminance difference B is positive (Yes in Step 205), it is determined that the subject has transferred to the left (Step 206). In the case where the slope of the luminance difference B is negative (No in Step 205), it is determined that the subject has transferred to the right (Step 207).

In Step 102, an orientation of transfer or a transfer direction of the subject M is detected on the basis of the orientations of transfer and the transfer directions detected in the respective pixels. Typically, as a result of displacement detection performed on the respective pixels, the most common orientation of transfer and the most common transfer direction are detected as the orientation of transfer and the transfer direction of the subject M. The method of detecting an orientation and a transfer direction of the subject M is not limited to the method of statistically determining results of displacement detection of the respective pixels. It is possible to use any algorithm.

The displacement detection of the respective pixels illustrated in FIG. 9 is also performed on pixels and the like including no speckle S. With regard to such pixels, sometimes a detection result that is different from the movement of the subject M may be obtained. On the other hand, the speckle image 25 of one frame includes many transfer images 27 that extend along transfer directions, and the transfer images 27 are gradationally displayed in accordance with their orientations of transfer. Accordingly, by comprehensively determining detection results of the respective pixels, it is possible to detect the orientation of transfer and the transfer direction of the subject M with very high accuracy.

The present inventors have done the following simulation by using speckle images generated under predetermined conditions. In other words, a composite image has been generated by synthesizing the following five images.

First image: a speckle image.

Second image: an image obtained by reducing luminance values of respective pixels of the first speckle image at a predetermined rate and shifting the pixels displayed with the luminance values to the right by one pixel in the horizontal direction.

Third image: an image obtained by reducing the luminance values of the respective pixels of the second speckle image at the same rate and shifting the pixels displayed with the luminance values to the right by one pixel in the horizontal direction.

Fourth image: an image obtained by reducing the luminance values of the respective pixels of the third speckle image at the same rate and shifting the pixels displayed with the luminance values to the right by one pixel in the horizontal direction.

Fifth image: an image obtained by reducing the luminance values of the respective pixels of the fourth speckle image at the same rate and shifting the pixels displayed with the luminance values to the right by one pixel in the horizontal direction.

The composite image is an image similar to a speck image of one frame obtained in the case where the parameter control for displacement detection illustrated in FIG. 2 has been exerted and the subject M has transferred to the right by four pixels in the horizontal direction.

The algorithm illustrated in FIG. 7 to FIG. 9 is applied to the composite image. As a result, pixels transferred to the right in the horizontal direction most commonly appear as the displacement result, and there is a significant difference in the number of such pixels and the number of pixels having other displacement results. In other words, it is understood that the algorithm illustrated in FIG. 7 to FIG. 9 makes it possible to accurately detect the displacement of the subject M.

Note that, it is difficult to detect the orientation of transfer of the subject M when using the image signal of the speckle image acquired in the comparative example illustrated in FIG. 6.

It is possible to acquire an image signal of one frame including the gradational transfer image 27 when the parameter control for displacement detection is exerted as described above. This makes it possible to accurately generate transfer information including an orientation of transfer and a transfer direction of the subject M by comparing a plurality of pixel signals included in an image signal. As a result, it is possible to accurately detect a displacement of the target M.

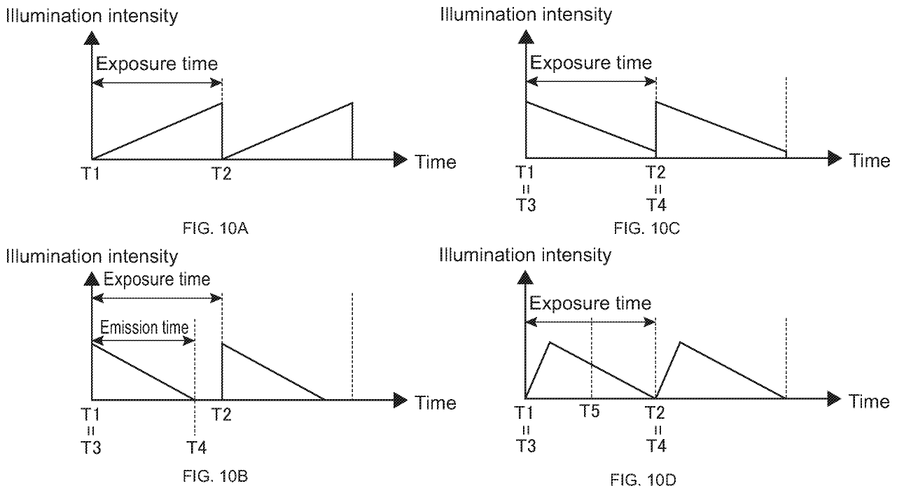

FIG. 10 is schematic graphs illustrating other examples of parameter control for displacement detection. As illustrated in FIG. 10A, the laser light source 11 may be controlled in a manner that illumination intensity increases from the exposure start time T1 to the exposure end time T2. Also in this case, it is possible to generate an image signal including the gradational transfer image 27, and it is possible to accurately detect a displacement of the subject M. In this case, a relation between the orientation of transfer and the luminance values is opposite to the case where the illumination intensity is reduced. In other words, the relation opposite to the relation between the slope of the luminance difference and the orientation of transfer illustrated in FIG. 9 is obtained.

Emission time of the laser light L may be controlled as illustrated in FIG. 10B. Within exposure time, an emission start timing of the laser light L is referred to as T3, and an emission end timing of the laser light L is referred to as T4. The emission time of the laser light L is time from the emission start timing T3 to the emission end timing T4.

In the example illustrated in FIG. 10B, the emission start timing T3 is the same as the exposure start time T1. The emission end timing T4 is earlier than the exposure end time T2. Accordingly, in FIG. 10B, the emission time is controlled in a manner that the illumination time of the laser light L is shorter than the exposure time. In other words, the emission time is controlled in a manner that the emission time in one frame to be exposed is shorter than time of one frame (exposure time). Note that, under the parameter control illustrated in FIG. 2 and FIG. 10A, the exposure time is the same as the illumination time (the emission time is not illustrated).

In addition, an amount of illumination light at the emission start timing T3 and an amount of illumination light at the emission end timing T4 are substantially equal to the illumination intensity at the exposure start time T1 and the illumination intensity at the exposure end time T2 illustrated in FIG. 2. Therefore, slope of change in the amount of illumination light is larger than that obtained under the parameter control illustrated in FIG. 2.

For example, in the case where a transfer speed of the subject M is fast, the transfer image 27 extending along the transfer direction has a long length. In addition, the gradation has low contrast because light reception amounts of the respective pixels decrease. As a result, there is a possibility that accuracy of movement detection based on the gradational transfer image 27 gets lower.

As illustrated in FIG. 10B, it is possible to suppress unnecessary extension of the gradational transfer image 27 by shortening the illumination time than the exposure time. In addition, it is possible to suppress reduction in the contrast of the gradation by increasing the slope of the change in the amount of illumination light. As a result, it is possible to accurately detect movement of the subject M even in the case where a movement speed of the subject M is fast. Note that, it is possible to achieve similar effects even in the case where illumination intensity is increased. Hereinafter, sometimes description of a fact that similar effects can be obtained even in the case where reduction in the illumination intensity is replaced with increase in the illumination intensity will be omitted.

As illustrated in FIG. 10C, the laser light source 11 is controlled in a manner that illumination intensity is reduced from the exposure start time T1 to the exposure end time T2. In addition, the intensity of the laser light L does not fall to zero at the exposure end time T2. The intensity of the laser light L is offset by a predetermined amount. Therefore, slope of the change in the illumination intensity illustrated in FIG. 10C is gentler than the slope obtained under the parameter control illustrated in FIG. 2.

For example, in the case where a transfer speed of the subject M is slow, a long emission time is favorable because the transfer image 27 extending along the transfer direction has a short length. With regard to the gradation, a difference in illumination intensity between the start of emission and the end of emission is favorably large.

In the case where the intensity is offset as illustrated in FIG. 10C, implementation is easy because small modulation control is exerted without turning off the laser light source 11. In addition, it is possible to exert parameter control for displacement detection under simple control in a manner that the illumination intensity is increased in accordance with an exposure start time T1 of next exposure time without turning off the laser light source 11.

In the case where information related to the transfer speed of the subject M is obtained in advance, it is possible to automatically set the length of the emission time and the slope of the illumination intensity on the basis of the information. For example, sometimes an operator who observes the subject M may input information related to a transfer speed of the observation target.

Alternatively, it is also possible to estimate the transfer speed of the subject M on the basis of a captured speckle image, and control length of emission time and the like in accordance with the estimated transfer speed. For example, the speckle image has lower contrast as a transfer speed of a speckle pattern increases. It is possible to calculate speckle contrast (SC) of respective pixels and estimate a transfer speed of the subject M on the basis of calculated values of the speckle contrast.

For example, a pixel bock in a predetermined size is set for calculating the SC. Examples of the pixel bock include a 3×3 picture block, a 7×7 pixel block, and a 13×13 pixel block. The pixel block is set around a SC calculation target pixel, and the SC is calculated by using the following formula and luminance values of respective pixels included in the pixel block.

SC=Standard deviation of luminance values/Average of luminance values

For example, in the case where an average or the like of the SC of the pixels is small, it is possible to estimate that the subject M has a fast transfer speed. In the case where the average or the like of the SC of the pixels is large, it is possible to estimate that the subject M has a slow transfer speed. It is possible to improve accuracy of movement information of the subject M by controlling the length of the emission time and the like on the basis of such estimation results.

Note that, it is also possible to estimate the transfer speed of the subject M on the basis of the length of the transfer image 27 or the like. It is possible to use a value obtained by dividing the length of the transfer image 27 by the exposure time, as an estimated value of the transfer speed. Alternatively, it is also possible to directly control the length of the emission time and the like on the basis of the length of the transfer image 27. For example, in the case where the length of the transfer image 27 is longer than a predetermined threshold, the emission time is controlled in a manner that the emission time is shortened.

As the parameter control for displacement detection, exposure time of the image capturing unit 20 may be controlled on the basis of the transfer speed or the like of the subject M. For example, in the case where the transfer speed of the subject M is fast, the exposure time may be shortened. This makes it possible to improve detection accuracy of movement of the subject M. It is sufficient to appropriately control parameters in a manner that the gradational transfer image 27 appropriate for the displacement detection is generated.

As the movement information, it is possible to acquire the transfer speed generated on the basis of the length of the transfer image 27 and the SC of the pixels.

As illustrated in FIG. 10D, the illumination intensity may be increased and decreased within the exposure time. It is possible to exert any illumination intensity control as long as gradation from which a displacement can be detected can be generated in the transfer image 27.

For example, as illustrated in FIG. 10D, the illumination intensity is changed in a manner that change in the illumination intensity within the exposure time is asymmetric change across intermediate time T5 of the exposure time. This makes it possible for the transfer image 27 to include asymmetric gradation across a central portion. For example, it is assumed that a subject transfers to the right by four pixels as illustrated in FIG. 5. The luminance rapidly increases from the pixel P1 to the pixel P2, and the luminance decreases toward the pixel P5. Accordingly, it is possible to determine that the subject M transfers toward the change direction. The same applies to any other control that results in asymmetric illumination intensity.

In addition, the intensity of the laser light L may be changed in a manner that illumination intensity obtained at the emission start timing T3 of the laser light L within the exposure time is different from illumination intensity obtained at the emission end timing T4 of the laser light L. This makes it possible to determine an orientation of transfer on the basis of luminance values at both ends of the transfer image 27. For example, as illustrated in FIG. 2 and FIG. 10A to FIG. 10C, determination accuracy gets higher as the difference in illumination intensity between the start of the emission and the end of the emission increases. In addition, it is also possible to increase contrast of gradation of the transfer image 27.

As illustrated in FIG. 2 and FIG. 10A to FIG. 10C, the present technology is not limited to the case where the illumination intensity changes on a linear function basis. The illumination intensity may increase/decrease on a quadratic function basis. In addition, it is sufficient to appropriately control illumination in a manner that the gradational transfer image 27 appropriate for the displacement detection is generated.

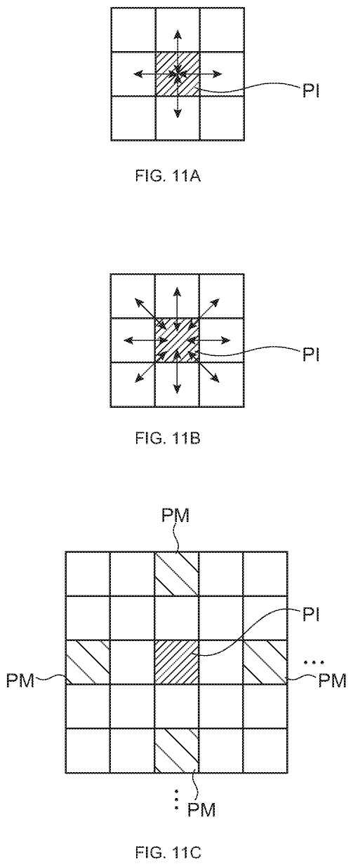

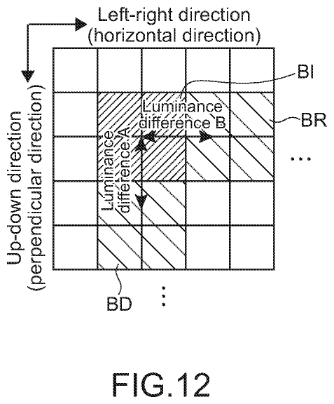

FIG. 11 and FIG. 12 are schematic diagrams for describing other examples of displacement detection of each pixel. As illustrated in FIG. 11A, it is possible to compare luminance values of four pixels with a luminance value of the target pixel PI. The four pixels are adjacent to the target pixel PI in the horizontal direction (left-right direction) and the perpendicular direction (up-down direction). This makes it possible to improve comparison accuracy of the gradient and determination accuracy of the slope of the luminance difference illustrated in FIG. 9, and it is possible to accurately detect movement of the subject M.

As illustrated in FIG. 11B, it is also possible to compare luminance values of all adjacent pixels around the target pixel PI. In other words, luminance values of not only adjacent pixels in the horizontal direction (left-right direction) and the perpendicular direction (up-down direction) but also adjacent pixels in oblique directions are compared with the luminance value of the target pixel PI. This makes it possible to detect transfer in the oblique directions and orientations of the transfer. For example, in the case where the most common detection results indicate a right diagonal direction and an upper right orientation of pixels, the orientation of transfer and the transfer direction of the subject M is detected as the upper right orientation and the right diagonal direction.

Note that, it is also possible to detect an oblique transfer direction even in the case of using detection results only in the horizontal direction (left-right direction) and the perpendicular direction (up-down direction) as illustrated in FIG. 8 and FIG. 11A. For example, an oblique direction may be detected as a transfer direction when statistically determining a rate or the like of detection results detected using pixels in the left-right direction and the up-down direction. For example, in the case where a rate of detection results of the horizontal direction and the right orientation is approximately 50% and a rate of detection results of the up-down direction and the upward orientation is also approximately 50%, a right diagonal direction and an upper right orientation may be detected as the transfer direction and the orientation of transfer.

As illustrated in FIG. 11C, instead of the pixels adjacent to the target pixel PI, it is possible to select pixels distant by a predetermined distance from the target pixel PI as comparison target pixels PM which are targets of luminance value comparison. For example, as illustrated in FIG. 11C, it is possible to select pixels disposed one pixel away from the target pixel PI in the horizontal direction (left-right direction) and the perpendicular direction (up-down direction) as the comparison target pixels PM. This makes it possible to achieve high detection accuracy in the case where a movement speed of the subject M is fast. The distance between the target pixel PI and the comparison target pixels PM is not limited. In addition, the distant direction is not limited. As the comparison target pixels PM, it is also possible to select not only the pixels distant in the left-right direction) and the perpendicular direction (up-down direction) but also pixels distant in oblique directions.

As illustrated in FIG. 12, it is possible to detect a displacement for each pixel block in a predetermined size. For example, as illustrated in FIG. 12, a 2×2 pixel block is treated as a target block BI, which is a target of variant detection. In addition, the algorithm illustrated in FIG. 7 and FIG. 9 is applied to an image block BR disposed immediately to the right of the target block BI and an image block BD disposed immediately below the target block BI. In other words, a similar algorithm is applied to the pixel blocks instead of the pixels. Note that, for example, an average value or the like of luminance values of the respective pixels included in the image block is used instead of the luminance values of the respective pixels illustrated in FIG. 7 and FIG. 9.

This makes it possible to detect an orientation of transfer and a transfer direction of the subject M even in the case where the speckle image includes large speckles S. For example, in the example illustrated in FIG. 12, it is possible to accurately detect movement of the subject M in the case where a speckle S is generated and the size of the speckle S is substantially equal to the 2×2 pixel block. For example, it is sufficient to appropriately set the size of the pixel block on the basis of the size of the speckle S.

In addition, the present technology is not limited to the case of statistically determining detection results of the respective pixels (respective pixel blocks). It is also possible to detect a plurality of gradational transfer images 27 appearing in the speckle image. For example, in the case where the same result is obtained through the flowchart illustrated in FIG. 9 with regard to consecutive pixels (pixel blocks) that are adjacent in a predetermined direction, the consecutive pixels (pixel blocks) are determined as pixels (pixel blocks) included in the transfer image 27. This makes it possible to detect the gradational transfer image 27. It is possible to accurately detect movement of the subject M on the basis of the plurality of detected gradational transfer images 27.

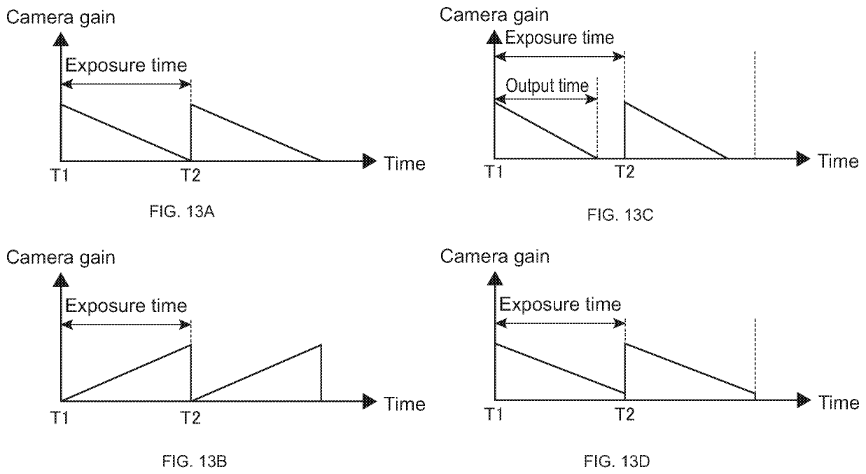

FIG. 13 is schematic graphs illustrating other examples of parameter control for displacement detection. As illustrated in FIG. 13, it is possible for the image capturing control section 31 to change camera gain (gain of image sensor) within the exposure time.

In an example illustrated in FIG. 13A, the camera gain is reduced from the exposure start time T1 to the exposure end time T2. In an example illustrated in FIG. 13B, the camera gain is increased from the exposure start time T1 to the exposure end time T2. In an example illustrated in FIG. 13C, the camera gain is controlled in a manner that output time of pixel signals is shorter than the exposure time. In an example illustrated in FIG. 13D, the camera gain is reduced from the exposure start time T1 to the exposure end time T2. In addition, the camera gain at the exposure end time T2 is offset by a predetermined amount.

As described above, it is also possible to generate the gradational transfer image 27 in the single speckle image by controlling camera gain. As a result, it is possible to accurately detect an orientation of movement and a movement direction of the subject M.

Note that, it is also possible to control both the illumination intensity and the camera gain as the parameter control for displacement detection. For example, the illumination intensity and the camera gain are changed in conjunction with each other within one exposure time in a manner that the gradational transfer image 27 is generated. As described above, it is also possible to control the plurality of image capturing parameters in conjunction with each other. Of course, it is also possible to control a parameter other than the illumination intensity or the camera gain as the parameter control for displacement detection.

As described above, in the signal processing system 100 according to this embodiment, an image capturing parameter of at least one of the illumination unit 10 or the image capturing unit 20 is changed within exposure time of the image capturing unit 20. In addition, movement information of the subject M is generated on the basis of an image signal of the subject M whose image has been captured by the image capturing unit 20. This makes it possible to detect a movement direction and the like of the subject M on the basis of the image signal obtained through one-time image capturing, for example. As a result, it is possible to accurately detect a displacement of the subject M.

For example, as described with reference to FIG. 4, sometimes change into a speckle pattern SP having a small correlation may occur when using the method of comparing a speckle pattern SP before transfer with a speckle pattern SP after the transfer, because of a large amount of transfer, a fast transfer speed, image capturing conditions, or the like. This makes it difficult to detect a displacement of the subject M.

In this embodiment, it is possible to detect a displacement of the subject M with very high accuracy on the basis of the gradational transfer images 27 included in the speckle image of one frame. Therefore, it is possible to detect the displacement of the subject M in real time without acquiring a plurality of speckle images.

Note that, the movement information related to movement of the subject M includes information related to movement relative to the signal processing system 100. In other words, the present technology makes it possible to accurately detect a displacement of the subject M relative to the signal processing system 100, that is, a relative displacement of the subject M occurred when the signal processing system 100 moves, for example. For example, it is also possible to acquire movement information including a relative orientation of movement and a relative movement direction of the subject M based on an image capturing position of the image capturing unit 20.

In addition, the present technology makes it possible to detect movement of the signal processing system 100 relative to the subject M. For example, it is also possible to acquire information including an orientation of movement and a movement direction of the image capturing unit 20 relative to the subject M. For example, it is assumed that a device or the like includes the illumination unit 10, the image capturing unit 20, and the signal processing device 30 illustrated in FIG. 1. In this case, the present technology makes it possible to detect movement of itself relative to the subject M, and it is possible to detect a displacement of the own device.

For example, the present technology is applicable to an endoscope, an optical microscope, and the like that are used in a medical/biological fields. In other words, the signal processing system 100 may be configured as the endoscope or the microscope.

In this case, examples of the subject M include a living tissue such as a cell, a tissue, or an organ of a living body. When using the present technology, it is possible to accurately detect a displacement of the living tissue. Of course, it is also possible to detect a displacement of a portion of the living tissue. For example, by performing the processes illustrated in FIG. 7 and FIG. 9, it is possible to accurately detect a displacement of a portion (region) that is a detection target in a speckle image on the basis of pixel signals of the portion.

For example, it is possible to detect a displacement of a partial tissue, a partial cell, or the like in an organ. Alternatively, the present technology makes it possible to detect a blood flow in a blood vessel. For example, it is possible to detect a direction, an orientation, a blood flow rate, and the like of the blood flow. Note that, change in the speckle patterns SP is large because the blood is liquid. However, it is possible to detect the blood flow by shortening exposure time, illumination time, output time, etc. and adjusting other image capturing environments and illumination environments.

In addition, the present technology is applicable to detection of various displacements in other fields. For example, the present technology is applicable to devices and systems in various fields such as a printer device, a conveyance device of substrates, etc., a self-propelled robot device, a mouse, or a drone.

### Another Embodiment

The present technology is not limited to the above-described embodiments. Various other embodiments are possible.

The example in which the laser light source is used as the illumination unit has been described above. Note that, the present technology is applicable to the case of using another coherent light source capable of emitting coherent light.

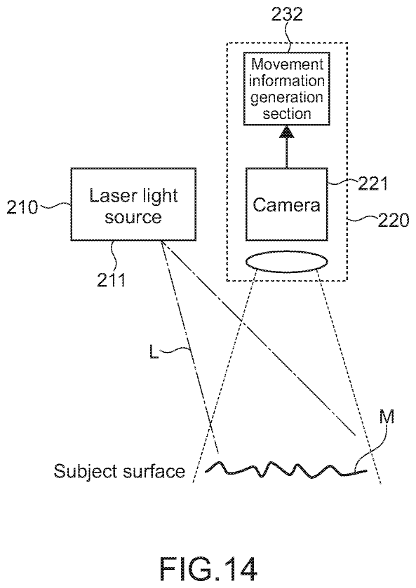

FIG. 14 is a diagram schematically illustrating another configuration example of a signal processing system. As described with reference to FIG. 3, it is possible for an image capturing unit 220 to generate movement information of the subject M in the case where the camera gain is controlled as the parameter control for displacement detection. In this case, the image capturing unit 220 functions as the signal processing device according to the present technology. In addition, a block that controls the camera gain of the image capturing unit 220 functions as the parameter control section. A movement information generation section 232 generates movement information of the subject M on the basis of an image signal output from the camera 221. Note that, constant intensity of laser light L output from a laser light source 211 of an illumination unit 210 is maintained.

Note that, it is possible for the illumination unit to also function as the signal processing device and generate the movement information of the subject M. Alternatively, the illumination unit, the image capturing unit, and the signal processing device may be integrated.

In addition, when a computer operated by the operator or the like and another computer capable of communication via a network work operate in conjunction with each other, a signal processing method and a program according to the present technology are executed, and this makes it possible to configure the signal processing system according to the present technology.

That is, the information processing method and the program according to the present technology may be executed not only in a computer system configured by a single computer but also in a computer system in which a plurality of computers operates in conjunction with each other. It should be noted that in the present disclosure, the system means an aggregate of a plurality of components (device, module (parts), and the like) and it does not matter whether or not all the components are housed in the same casing. Therefore, a plurality of devices housed in separate casings and connected to one another via a network and a single device having a plurality of modules housed in a single casing are both the system.

The execution of the information processing method and the program according to the present technology by the computer system includes, for example, both of a case where a single computer controls image capturing parameters for displacement detection, acquires movement information of a subject, etc., and a case where those processes are executed by different computers. Further, the execution of the respective processes by predetermined computers includes causing another computer to execute some or all of those processes and acquiring results thereof.

That is, the information processing method and the program according to the present technology are also applicable to a cloud computing configuration in which one function is shared and cooperatively processed by a plurality of devices via a network.

Out of the feature parts according to the present technology described above, at least two feature parts can be combined. That is, the various feature parts described in the embodiments may be arbitrarily combined irrespective of the embodiments. Further, various effects described above are merely examples and are not limited, and other effects may be exerted.

Note that, the present technology may also be configured as below.

(1) A signal processing system including:

an illumination section that emits laser light to a target;

an image capturing section that captures an image of the target irradiated with the laser light;

a parameter control section that changes a parameter related to image capturing of at least one of the illumination section or the image capturing section within exposure time of the image capturing section; and

an acquisition section that acquires movement information related to movement of the target on the basis of an image signal of the target whose image is captured by the image capturing section.

(2) The signal processing system according to (1),

in which the acquisition section acquires the movement information on the basis of information related to a speckle generated through emission of the laser light to the target, the information related to a speckle being included in the image signal.

(3) The signal processing system according to (1) or (2), in which

the image capturing section includes an image sensor that generates the image signal, and

the parameter control section changes at least one of intensity of the laser light or gain of the image sensor within the exposure time.

(4) The signal processing system according to (3),

in which the parameter control section changes the intensity of the laser light in a manner that change in the intensity of the laser light within the exposure time is asymmetric change based on intermediate time of the exposure time.

(5) The signal processing system according to (3) or (4),

in which the parameter control section changes the intensity of the laser light in a manner that intensity of the laser light obtained at an emission start timing of the laser light within the exposure time is different from intensity of the laser light obtained at an emission end timing of the laser light.

(6) The signal processing system according to any one of (3) to (5),

in which the parameter control section changes the intensity of the laser light in a manner that the intensity of the laser light increases or decreases within the exposure time.

(7) The signal processing system according to any one of (3) to (6),

in which the parameter control section is capable of controlling emission time from an emission start timing of the laser light to an emission end timing of the laser light within the exposure time.

(8) The signal processing system according to (7),

in which the parameter control section controls the emission time in a manner that the emission time is shorter than the exposure time.

(9) The signal processing system according to any one of (1) to (8),

in which the acquisition section acquires the movement information including a relative orientation of movement and a relative movement direction of the target based on an image capturing position of the image capturing section.

(10) The signal processing system according to any one of (1) to (9),

in which the acquisition section acquires information including a relative orientation of movement and a relative movement direction of the image capturing section with respect to the target.

(11) The signal processing system according to any one of (1) to (10),

in which the acquisition section acquires the movement information by comparing a plurality of pixel signals included in the image signal of the target with each other.

(12) The signal processing system according to any one of (1) to (11),

in which the illumination section includes at least one of a semiconductor laser, a gas laser, a solid-state laser, or a liquid laser.

(13) The signal processing system according to any one of (1) to (12),

in which the image sensor is a charge coupled device (CCD) sensor or a complementary metal oxide semiconductor (CMOS) sensor.

(14) The signal processing system according to any one of (1) to (13),

in which the signal processing system is configured as an endoscope or a microscope.

(15) The signal processing system according to any one of (1) to (14),

in which the target is a living tissue.

(16) A signal processing device including:

a parameter control section that changes a parameter related to image capturing of at least one of an illumination section or an image capturing section within exposure time of the image capturing section that captures an image of a target irradiated with laser light emitted from the illumination section; and

an acquisition section that acquires movement information related to movement of the target on the basis of an image signal of the target whose image is captured by the image capturing section.

(17) A signal processing method that is executed by a computer system, the signal processing method including:

changing a parameter related to image capturing of at least one of an illumination section or an image capturing section within exposure time of the image capturing section that captures an image of a target irradiated with laser light emitted from the illumination section; and

acquiring movement information related to movement of the target on the basis of an image signal of the target whose image is captured by the image capturing section.

### REFERENCE SIGNS LIST

T1 exposure start time
T2 exposure end time
T3 emission start timing
T4 emission end timing
T5 intermediate time of exposure time
10, 210 illumination unit
11, 211 laser light source
20, 220 image capturing unit
21, 221 camera
27 transfer image
30 signal processing device
31 image capturing control section
32, 232 movement information generation section
100 signal processing system

1. A signal processing system comprising:
an illumination section that emits laser light to a target;
an image capturing section that captures an image of the target irradiated with the laser light;
a parameter control section that changes a parameter related to image capturing of at least one of the illumination section or the image capturing section within exposure time of the image capturing section; and
an acquisition section that acquires movement information related to movement of the target on a basis of an image signal of the target whose image is captured by the image capturing section.

2. The signal processing system according to claim 1,
wherein the acquisition section acquires the movement information on a basis of information related to a speckle generated through emission of the laser light to the target, the information related to a speckle being included in the image signal.

3. The signal processing system according to claim 1, wherein
the image capturing section includes an image sensor that generates the image signal, and
the parameter control section changes at least one of intensity of the laser light or gain of the image sensor within the exposure time.

4. The signal processing system according to claim 3,
wherein the parameter control section changes the intensity of the laser light in a manner that change in the intensity of the laser light within the exposure time is asymmetric change based on intermediate time of the exposure time.

5. The signal processing system according to claim 3,
wherein the parameter control section changes the intensity of the laser light in a manner that intensity of the laser light obtained at an emission start timing of the laser light within the exposure time is different from intensity of the laser light obtained at an emission end timing of the laser light.

6. The signal processing system according to claim 3,
wherein the parameter control section changes the intensity of the laser light in a manner that the intensity of the laser light increases or decreases within the exposure time.

7. The signal processing system according to claim 3,
wherein the parameter control section is capable of controlling emission time from an emission start timing of the laser light to an emission end timing of the laser light within the exposure time.

8. The signal processing system according to claim 7,
wherein the parameter control section controls the emission time in a manner that the emission time is shorter than the exposure time.

9. The signal processing system according to claim 1,
wherein the acquisition section acquires the movement information including a relative orientation of movement and a relative movement direction of the target based on an image capturing position of the image capturing section.

10. The signal processing system according to claim 1,
wherein the acquisition section acquires information including a relative orientation of movement and a relative movement direction of the image capturing section with respect to the target.

11. The signal processing system according to claim 1,
wherein the acquisition section acquires the movement information by comparing a plurality of pixel signals included in the image signal of the target with each other.

12. The signal processing system according to claim 1,
wherein the illumination section includes at least one of a semiconductor laser, a gas laser, a solid-state laser, or a liquid laser.

13. The signal processing system according to claim 1,
wherein the image sensor is a charge coupled device (CCD) sensor or a complementary metal oxide semiconductor (CMOS) sensor.

14. The signal processing system according to claim 1,
wherein the signal processing system is configured as an endoscope or a microscope.

15. The signal processing system according to claim 1,
wherein the target is a living tissue.

16. A signal processing device comprising:
a parameter control section that changes a parameter related to image capturing of at least one of an illumination section or an image capturing section within exposure time of the image capturing section that captures an image of a target irradiated with laser light emitted from the illumination section; and
an acquisition section that acquires movement information related to movement of the target on a basis of an image signal of the target whose image is captured by the image capturing section.

17. A signal processing method that is executed by a computer system, the signal processing method comprising:
changing a parameter related to image capturing of at least one of an illumination section or an image capturing section within exposure time of the image capturing section that captures an image of a target irradiated with laser light emitted from the illumination section; and
acquiring movement information related to movement of the target on a basis of an image signal of the target whose image is captured by the image capturing section.
